(19) United States
(12) Patent Application Publication
(10) Pub. No.: US 2008/0257823 A1
(43) Pub. Date: Oct. 23, 2008

(54) Process for the Preparation of an Adsorbent Material Containing Iron Oxyhydroxide, Adsorbent Material and the Use Thereof

(75) Inventor: Mika Martikainen, Oulu (FI)

Correspondence Address: CANTOR COLBURN, LLP, 20 Church Street, 22nd Floor, Hartford, CT, 06103, US

(73) Assignee: KEMIRA OJY, Helsinki (FI)

(21) Appl. No.: 11/575,911

(22) PCT Filed: Sep. 23, 2005
(86) PCT No.: PCT/FI2005/000403

§ 371 Date: Apr. 15, 2008

(30) Foreign Application Priority Data
Sep. 24, 2004 (FI) 20041235

(51) Int. Cl. C01G 49/02; B01D 15/00

(52) U.S. Cl. 210/660; 423/632

(57) ABSTRACT

The invention relates to a process for producing an adsorbent material containing iron oxyhydroxide, wherein an iron oxyhydroxide mass having a moisture content of 5-15% by weight is produced, said mass is granulated by compaction, followed by comminution and sieving of the compacted product to give product granules with grain sizes ranging between 0.5 and 4 mm. The invention is also relates to a granular adsorbent material containing iron oxyhydroxide, the grain size of the granules being between 0.5 and 4 mm, and the bulk density thereof being from 0.8 to 1.5 g/cm³. Said adsorbent material may be used for removing harmful substances, particularly arsenic, from an aqueous solution thereof.

### FIELD OF THE INVENTION

The invention relates to a process for preparing an adsorbent material containing iron oxyhydroxide FeO(OH). Further, the invention relates to an adsorbent material containing iron oxyhydroxide FeO(OH) useful for removing arsenic, heavy metals and/or phosphorus from aqueous solutions thereof.

In this specification and in the appended claims, the term “heavy metals” includes at least one of the following elements:
Pb, Cr, Cu, Mo, Cd, Ni, and Zn.

### PRIOR ART

Arsenic and heavy metals are very toxic, thus presenting a serious hazard to people and the environment. Arsenic and heavy metals in the soil are a cause of pollution in numerous sites all over the world. Typical sites polluted by heavy metals include former industrial areas, landfills, and shooting ranges. Heavy metal contamination of the soil in such sites may be very high. Normally, some dissolution of these heavy metals in water takes place, and accordingly, they may for instance be dissolved in rain water. Depending on the migration thereof, dissolved heavy metals cause pollution in ground or surface water bodies.

Current techniques used to solve these problems are relatively expensive, and thus the application thereof is at present rather limited. In many cases, soil contaminated with dissolved heavy metals is left untreated. For this reason, efficient and inexpensive treatment processes are needed.

Phosphorus both in solid and in liquid forms is found in waste waters. There are conventional methods for removing phosphorus from municipal waste waters, but waste waters are not always treated for phosphorus removal in sparsely populated areas. These waste waters may be released in the environment without any previous treatment. In addition, water streams containing phosphorus may also be washed from fields and reach lakes or the sea without any treatment. In agriculture, great amounts of phosphorus are used as fertilizers applied to the fields. Such waste waters cause eutrophication of water bodies.

At present, it is not necessary to remove phosphorus from waste water in sparsely populated areas, but, however, a novel European legislation is expected in this field in a few years time. For this reason, there is a need to develop new inexpensive and efficient techniques for phosphorus removal, particularly for areas without a connection to municipal waste water systems.

It is well known that arsenic and heavy metals may be removed from an aqueous solution by filtering through a solid layer comprising iron(III) oxide and/or iron(III) hydroxide. Such processes are particularly designed for applications for arsenic removal.

There are numerous places in the world where arsenic is present at high concentrations in the ground water. According to the recommendations of the World Health Organization, WHO, the maximum concentration of asenic may not exceed the value of 10 μg/l.

Arsenic is present in the ground water as As(III) and As(V) form, at various ratios. In deep wells with less oxygen, the dominant form is normally As(III). Most processes for arsenic removal only remove As(V) efficiently. For this reason, a pretreatment is used for oxidizing the arsenite to the arsenate form. Oxygen, ozone, free chlorine, hypochlorite, permanganate, hydrogen peroxide, or Fenton's reagent may be used for this oxidation.

Arsenic may be removed from drinking water by coagulation, or adsorption. For instance, alum Al₂(SO₄)₃, ferric chloride FeCl₃ or ferric sulphate Fe₂(SO₄)₃·7H₂O may be used as coagulants. Based on weight, arsenic is more efficiently removed by ferric salts than by alum, and further, ferric salts may be used in wider pH ranges. In both cases, the pentavalent arsenic may be more efficiently removed than the trivalent arsenic.

Published application US 2002/0070172 A2 discloses a granular adsorbent reported to be particularly suitable for arsenic removal from aqueous solutions. Said granules contain iron oxide and/or iron oxyhydroxide. Said granules are typically produced by adding sodium hydroxide to a ferrous sulphate solution, followed by oxidation of the suspension thus obtained with air. The resulting suspension is filtered and washed to give a pasty filter cake, which is then dried to a moisture content of for instance 3% by weight. The solid, very hard product thus obtained consisting of iron oxyhydroxide is then comminuted e.g. to a grain size between 0.5 and 2 mm. Said granules may also be produced by forcing the pasty filter cake through a perforated plate to form strands, and thereafter, said strands are dried to a moisture content of e.g. 3% by weight, and comminuted. The products obtained are said to have a large specific surface area.

The patent application WO 97/38944 of the present applicant discloses a process for producing a pure product containing ferric iron. In this process, the starting material comprises hydrous ferrous sulphate obtained as a by-product in the process for producing titanium dioxide. Said ferrous sulphate is oxidized using oxygen in a pressurized vessel, at elevated temperatures. During this oxidation, the ferrous salt is dissolved by its own crystal water, this dissolution being associated with the simultaneous precipitation of hydronium jarosite. The reaction equation is as follows:

5FeSO₄×H₂O+11/4O₂→H₃OFe₃(OH)₆(SO₄)₂(s)+Fe₂(SO₄)₃(I)

During the oxidation stage, an equilibrium between the ferric sulphate solution and the hydronium jarosite is established. About half of the iron is thus present in the solution in a dissolved form and the other half is in a precipitated form as the hydronium jarosite. Solid jarosite is separated by filtration and used for producing pure chemicals for water treatment. A solution containing ferric sulphate is obtained as a remainder. The use of this solution has proven problematic due to considerable amounts produced relative to hydronium jarosite. The storage thereof is complicated and expensive. As a further difficulty, most of the impurities of the original ferrous sulphate, especially manganese, is present in the solution.

EP 0 997 436 of the present applicant presents a method for processing the by-product obtained in the above hydronium jarosite production process, that is, the impure ferric sulphate solution, to give a solution containing ferric iron useful for water treatment. According to an embodiment of the method, a base is added to said impure ferric sulphate solution to elevate the pH initially having a typical value of about 1 to a value between about 2 and 5, preferably between about 3 and 4, to precipitate ferric hydroxide, or more specifically ferric oxyhydroxide. The precipitate may be separated by filtration. Thereafter, this precipitate may for instance be used for producing an iron chemical suitable for waste water treatment by dissolving the precipitate in an acid, particularly in nitric acid. Said method may also comprise a second precipitation step for precipitating an impurity metal such as manganese dioxide. In this second precipitation step, an oxidizing agent and a base are added to the solution to elevate the pH to a value between about 6 and 10, preferably about 8 and 9. In said precipitation steps, for instance MgO, Mg(OH)₂, MgCO₃, NH₃, NaOH, or KOH may be used as bases.

### OBJECT OF THE INVENTION

The object of the invention is to provide an adsorbent material containing iron oxyhydroxide, said adsorbent material efficiently adsorbing arsenic, heavy metals and/or phosphorus, being not substantially slurried in water, and having excellent mechanical properties.

### THE INVENTION

Thus, according to the invention, a process for producing an adsorbent material containing iron oxyhydroxide is provided, wherein an iron oxyhydroxide mass having a moisture content of 5-15% by weight is produced, said mass is granulated by compaction, followed by comminution and sieving of the compacted product to give product granules with grain sizes ranging between 0.5 and 4 mm.

Said iron oxyhydroxide mass having a moisture content of 5-15% by weight is a powder or substantially a powder.

In the dry granulation of the invention, said moisture content acts as a “binding agent”. The moisture content is preferably from 7 to 15% by weight, more preferably from 7 to 13% by weight.

In the process of the invention, the compaction may be carried out by compressing the mass to be granulated to give a shaped body, and the comminution may be carried out by crushing the shaped body.

According to a preferred embodiment, the mass to be granulated is compacted between two rotating rolls to obtain a sheet. In this case, a preferable apparatus comprises a compactor wherein the mass to be granulated is forced by means of a screw conveyor between two rotating rolls for compressing the mass to a sheet. The sheet is crushed for instance using a hammer crusher, followed by sieving the crushed granules through a vibration sieve to give the desired size class (e.g. from 1 to 2 mm, and from 2 to 4 mm). Fine particles (e.g. less than 1 mm) are recycled back to the screw conveyor and coarse material (e.g. more than 4 mm) is recycled to the crusher. The strength of the product granules may be influenced by the compression force. The force is regulated by adjusting the roll nip and the rotation speed of the screw conveyor. The grain size of the product passed to the sieve is determined by the mesh size of the net on the bottom of the crusher. The compressive force is preferably between 40 and 160 kN.

As for the grain size, preferably at least 50% by weight of the granules of the product belong to one or two of the following size classes: 0.5-1 mm, 1-2 mm, and 2-4 mm. More preferably, at least 70% by weight of said granules belong to one or two of the size classes.

The compaction method of the invention gives product granules having a bulk density varying from 0.5 to 1.5 g/cm³, preferably from 0.8 to 1.3 g/cm³ and more preferably from 0.9 to 1.2 g/cm³.

According to the invention the iron oxyhydroxide mass having a moisture content of 5-15% by weight is preferably produced from an iron oxyhydroxide filter cake by drying.

Said iron oxyhydroxide mass may be derived from materials based on iron sulphate, iron chloride or iron nitrate.

According to a preferable embodiment, said material based on iron sulphate is a ferric sulphate solution obtained as a by-product in the hydronium jarosite production process.

According to a particularly preferred embodiment, said iron oxyhydroxide mass having a moisture content of 5-15% by weight is produced by adding a base to a ferric sulphate solution obtained as a by-product in the hydronium jarosite production process to precipitate the iron oxyhydroxide, followed by separation of the precipitated iron oxyhydroxide by filtration, and drying of the filter cake. Such a filter cake may be produced according to the method described in EP 0 997 436. Said base may be selected from the group consisting of magnesium oxide, hydroxide, and carbonate, ammonium, sodium hydroxide, and potassium hydroxide.

In the process of the invention, the drying of the final product is not necessary due to the low moisture content of the iron oxyhydroxide mass ranging from 5 to 15% by weight, the moisture content of the final product thus being substantially similar to that of the iron oxyhydroxide mass to be granulated.

The invention is also directed to an adsorbent material containing iron oxyhydroxide, produced by the process of the invention.

According to the invention, also a granular adsorbent material containing iron oxyhydroxide is provided, the grain size of the granules being between 0.5 and 4 mm, and the bulk density thereof being from 0.8 to 1.5 g/cm³.

As for the grain size, preferably at least 50% by weight, more preferably at least 70% by weight of the granules belong to one or two of the following size classes: 0.5-1 mm, 1-2 mm, and 2-4 mm.

The bulk density of the granules preferably ranges from 0.8 to 1.3 g/cm³ and more preferably from 0.9 to 1.2 g/cm³.

The granules are mechanically very resistant. The crushing strength of the granules is preferably at least 2 N. In case of granules, of which at least 50% by weight, more preferably at least 70% by weight, belong to the size class of 1-2 mm, the crushing strength thereof is preferably at least 5 N. In case of granules, of which at least 50% by weight, more preferably at least 70% by weight, belong to the size class of 2-4 mm, the crushing strength thereof is preferably at least 20 N, more preferably at least 30 N.

Moisture content of the granules is preferably from 5 to 15% by weight, more preferably from 7 to 15% by weight, and even more preferably from 7 to 13% by weight.

The invention further relates to the use of the adsorbent material produced according the invention, or the adsorbent material of the invention for removing at least one harmful substance from an aqueous solution thereof. The harmful substance to be removed is preferably arsenic, a heavy metal, a non-metal such as selenium, or phosphorus, or another substance like natural organic matter (NOM). The adsorbent material is particularly suitable for use to remove arsenic from aqueous arsenic solutions, especially from drinking water.

According to the invention, the aqueous solution to be treated may be ground water, drinking water, industrial waste water as for instance from electronic or electroplating industries, or an aqueous solution washed by rain or melted snow from polluted areas and/or agricultural areas fertilized with phosphorus.

The adsorbent material according to the invention may for instance be used in solid layer filters. Such filters (two or more) may be installed in parallel to obtain a maximum flow-through, or they may be connected in series to obtain a maximum purity. It is of course possible to use systems having a single solid layer filter. The adsorbent material may also be used in other kinds of treatment processes wherein impure or contaminated solution is purified by passing it through the adsorbent material, or by reacting it with the adsorbent material, followed by separation thereof from the purified solution.

The adsorbent material according to the present invention may be used in different ways to remove arsenic, heavy metals, phosphorus and/or other harmful substances.

According to an embodiment of the invention, in applications for removing heavy metals and/or arsenic from contaminated areas such as former industrial sites, landfills or shooting ranges, first the route of travel of the water washed from these sites is determined, followed by addition of the adsorbent material in this route on the basis of the obtained results to pass the water washed from the contaminated soil through the adsorbent material. Such a system may be called a soil filter, or a reactive wall. The adsorbent material entraps the heavy metals and/or arsenic, and accordingly, the water reaching ground water, lakes, the sea, or rivers, is free or substantially free from heavy metals and/or arsenic. The necessary amount of the adsorbent material is for instance estimated by analyzing soil samples. Moreover, the amount of the adsorbent material needed depends on the desired service life. The service life may e.g. vary between 10 and 50 years. The quality of the filtered water may be regularly monitored. The exchange of the adsorbent material is implied by quality reductions.

The above principle may also be applied to phosphorus removal from water washed from fields, or from waste water produced in sparsely populated areas.

According to another embodiment of the invention, contaminated water or waste water containing heavy metals, arsenic and/or phosphorus washed from contaminated area is passed to a storage tank. The contaminated water is passed from this tank to another tank to be contacted with the adsorbent material. Then the mixture is agitated for a suitable time. This is followed by filtration of the mixture, and release of the filtrate free or substantially free of heavy metals, arsenic and/or phosphorus to a lake, the sea, or a river. The obtained precipitate containing heavy metals and/or arsenic may be reused, but, however, the removal of this precipitate from the treatment system and replacement thereof with fresh adsorbent material will at some point become necessary.

In this specification, all percentages are by weight unless otherwise indicated. The moisture content is determined by Karl Fischer titration. Crushing strength is determined with Ta.XT plus Texture Analyser of the company Stable Micro Systems Ltd. For operating this apparatus, one granule is placed on the assay plate, a vertically moving sensor being arranged above this plate. Once the contact with the grain is recognized by the sensor, the velocity thereof is reduced for compression. The force at the moment of the yield of the granule sensed by the sensor is recorded as the crushing strength. The result is the average of 30 measurements.

The present invention is illustrated below in more detail by the following examples.

### EXAMPLE 1

FeO(OH) was produced according to EP 0 997 436. After filtering, the moisture content of the FeO(OH) mass was 45%. The product was dried in a forced air drying chamber to the moisture content of 10%. Drying temperature was 70° C. The drying process was monitored by assaying the water content using Karl Fischer titration.

A solution of As(V) was prepared from a commercially available arsenic standard produced by Reagecon. The concentration of the arsenic standard solution was 1000 mg/l As(V).

For arsenic removal tests, a solution containing 1 mg/l of arsenic in ion exchanged water was prepared. In these arsenic removal tests, four different weighed charges of the adsorbents to be tested were used. In each test, the product was added into the water containing arsenic, followed by the adjustment of the pH to a value of 6.2 with 10% NaOH. Thereafter, the solution was agitated for 1 hour prior to filtering through a 1.2 μm membrane. Arsenic, As, in the filtrate was analyzed using AAS FIAS hybrid method (FIAS-ASS, Determination of arsenic by atomic absorption spectrophotometry using the hybrid technique. SFS-EN ISO 11969). The arsenic removal (%) was calculated from the ratio of the analysed residual As content of the treated solution to initial As content of the water used as starting material.

TABLE I
Arsenic removal in tests using dried FeO(OH)

| FeO(OH) [mg/l] | As removal [%] |
|---|---|
| 60 | 77 |
| 179 | 99 |
| 357 | 99 |
| 536 | 99 |

As these results show, the dried FeO(OH) adsorbs more than 99% of the arsenic at concentrations >179 mg/l. A disadvantage of the product is the fact that it is completely slurried by water, and thus the separation thereof to obtain pure water is complicated.

### EXAMPLE 2

FeO(OH) was produced according to EP 0 997 436. After filtering, the moisture content of the FeO(OH) mass was 45%. The product was dried in a forced air drying chamber to the moisture content of 10%. Drying temperature was 70° C. The drying process was monitored by assaying the water content using Karl Fischer titration.

After drying, the product was granulated. The dry granulation was carried out by so-called compacting. In the compacting apparatus, the mass to be granulated is forced by a screw conveyor between two rotating rolls for compression thereof to give a sheet. The sheet is crushed for instance using a hammer crusher, followed by sieving of the crushed granules through a vibration sieve. The strength of the product granules may be influenced by the compression force. The force is regulated by adjusting the roll nip and the rotation speed of the screw conveyor. The grain size of the product is determined by the mesh size of the net on the bottom of the crusher.

After crushing, a fraction having a grain size less than 1 mm is sieved from the product for arsenic removal tests.

TABLE II
Arsenic removal in tests using granulated FeO(OH)
having a grain size less than 1 mm

| FeO(OH) [mg/l] | As removal [%] |
|---|---|
| 36 | 25.0 |
| 108 | 70.0 |
| 217 | 93.3 |
| 325 | 97.3 |

The data in Table II show that despite the increased grain size, arsenic is still excellently adsorbed by this product granulated to have a grain size less than 1 mm. The product is somewhat slurried by water, and accordingly, a separate filtering step is required.

### EXAMPLE 3

The product to be tested was prepared according to Example 2, with the exception that following crushing, a fraction with a grain size from 1 to 2 mm was sieved from the product. The bulk density of this fraction is 1.15 g/cm³, the crushing strength being 13 N. The arsenic removal capacity of this fraction was tested according to Example 1.

TABLE III
Arsenic removal in tests using granulated FeO(OH)
having a grain size from 1 to 2 mm

| FeO(OH) [mg/l] | As removal [%] |
|---|---|
| 36 | 9.0 |
| 108 | 43.0 |
| 217 | 78.0 |
| 325 | 93.2 |

The data in Table III show that despite the considerably increased grain size, arsenic is adsorbed by this product granulated to have a grain size from 1 to 2 mm. The product is not slurried by water, and accordingly, the separation thereof may be readily carried out after adsorption.

### EXAMPLE 4

The product to be tested was prepared according to Example 2, with the exception that following crushing, a fraction with a grain size from 2 to 4 mm was sieved from the product. The bulk density of this fraction is 0.98 g/cm³, the crushing strength being 43 N. The arsenic removal capacity of this fraction was tested according to Example 1.

TABLE IV
Arsenic removal in tests using granulated FeO(OH)
having a grain size from 2 to 4 mm

| FeO(OH) [mg/l] | As removal [%] |
|---|---|
| 36 | 15.0 |
| 108 | 46.0 |
| 217 | 81.0 |
| 325 | 91.8 |

The data in Table IV show that despite the great grain size, arsenic is adsorbed by this product granulated to have a grain size from 2 to 4 mm. The product is not slurried by water, and accordingly, the separation thereof may be readily carried out after adsorption.

### EXAMPLE 5

An aqueous solution containing 1 mg/l of lead as an impurity was prepared. The adsorbent material to be tested was prepared according to Example 2, with the exception that following crushing, a fraction with a grain size from 1 to 2 mm was sieved from the product. The ability of this fraction to bind lead was tested according to Example 1.

TABLE V
Lead removal in tests using FeO(OH) granulated
to a grain size from 1 to 2 mm

| FeO(OH) [mg/l] | Pb removal [%] |
|---|---|
| 36 | 19.0 |
| 108 | 55.0 |
| 217 | 85.0 |
| 325 | 94.0 |

As from the results of Table V may be seen, the product granulated to a grain size from 1 to 2 mm binds lead. Thus, the product may be used for treating waste water containing lead.

### EXAMPLE 6

Waste water with an analyzed phosphorus content of 4.2 mg/l was provided. The adsorbent material to be tested was prepared according to Example 2, with the exception that following crushing, a fraction with a grain size from 1 to 2 mm was sieved from the product. The ability of this fraction to bind phosphorus from waste water was tested according to Example 1. Dr Lange's phosphorus tubes and Cadas 30 spectrophotometer were used for phosphorus analysis.

TABLE VI
Phosphorus removal in tests using FeO(OH) granulated
to a grain size from 1 to 2 mm

| FeO(OH) [mg/l] | P removal [%] |
|---|---|
| 210 | 0.9 |
| 525 | 38.0 |
| 1680 | 76.3 |
| 3675 | 96.9 |

As from the results of Table VI may be seen, the product granulated to a grain size from 1 to 2 mm also binds phosphorus. Thus, the product may be used for treating waste water containing phosphorus.

### EXAMPLE 7

An aqueous solution with a copper concentration adjusted to 20 mg/l was prepared. The adsorbent material to be tested was prepared according to Example 2, with the exception that following crushing, a fraction with a grain size from 1 to 2 mm was sieved from the product. The ability of this fraction to bind Cu was tested according to Example 1.

TABLE VI
Copper removal in tests using FeO(OH) granulated
to a grain size from 1 to 2 mm

| FeO(OH) [mg/l] | Cu removal [%] |
|---|---|
| 750 | 15.0 |
| 2250 | 40.0 |
| 6750 | 78.0 |
| 15000 | 95.1 |

As from the results of Table VI may be seen, the product granulated to a grain size from 1 to 2 mm also binds copper. Thus, the product may be used for treating waste water containing copper.

1. Process for producing an adsorbent material containing granular iron oxyhydroxide product granules, comprising
producing an iron oxyhydroxide mass in powder form having a moisture content of 5-15% by weight,
granulating said mass by compaction to provide a compacted product, followed by
comminution and sieving of the compacted product to give product granules with grain sizes ranging between 0.5 and 4 mm.

2. Process according to claim 1, characterized in that said granulating by compaction is carried out by compressing the mass to be granulated to give a shaped body, and said comminution is carried out by crushing the shaped body.

3. Process according to claim 2, characterized in that said mass to be granulated is compressed between two rotating rolls to give a sheet.

4. Process according to claim 1, characterized in that at least 50% by weight of the product granules belong to one or two of the following grain size classes: 0.5-1 mm, 1-2 mm, and 2-4 mm.

5. Process according to claim 1, characterized in that the bulk density of the product granules ranges from 0.5 to 1.5 g/cm³.

6. Process according to claim 1, characterized in that said iron oxyhydroxide mass having a moisture content of 5-15% by weight is produced from an iron oxyhydroxide filter cake by drying.

7. Process according to claim 6, characterized in that said iron oxyhydroxide mass is derived from materials based on iron sulphate, iron chloride, or iron nitrate.

8. Process according to claim 7, characterized in that said material based on iron sulphate is a ferric sulphate solution obtained as a by-product in a hydronium jarosite production process.

9. Process according to claim 7, characterized in that said iron oxyhydroxide mass is produced by adding a base to a ferric sulphate solution obtained as a by-product in a hydronium jarosite production process to precipitate the iron oxyhydroxide, followed by separation of the precipitated iron oxyhydroxide by filtration, and drying of the filter cake.

10. Adsorbent material containing granular iron oxyhydroxide, characterized in that said material is produced with a process according to claim 1.

11. Adsorbent material containing iron oxyhydroxide, said material being granular, and having a grain size ranging from 0.5 to 4 mm, and a bulk density from 0.8 to 1.5 g/cm³.

12. Adsorbent material according to claim 11 characterized in that at least 50% by weight of the granules belong to one or two of the following grain size classes: 0.5-1 mm, 1-2 mm, and 2-4 mm.

13. Adsorbent material according to claim 11 characterized in that the bulk density of the granules ranges from 0.8 to 1.3 g/cm³.

14. Adsorbent material according to claim 11, characterized in that the crushing strength of the granules is at least 2 N.

15. Adsorbent material according to claim 14, characterized in that at least 50% by weight of the granules belong to the grain size class of 1-2 mm, the crushing strength of the granules being at least 5 N.

16. Adsorbent material according to claim 14, characterized in that at least 50% by weight of the granules belong to the grain size class of 2-4 mm, the crushing strength of the granules being at least 20 N.

17. Adsorbent material according to claim 1, characterized in that the moisture content of the granules ranges from 5 to 15% by weight.

18. (canceled)

19. (canceled)

20. A method of removing at least one harmful substance from an aqueous solution thereof, comprising contacting the aqueous solution with the absorbent material of claim 1.

21. The method of claim 20, characterized in that said harmful substance to be removed is arsenic, a heavy metal, a non-metal such as selenium, or phosphorus.
